(19) United States
(12) Patent Application Publication
(10) Pub. No.: US 2026/0075287 A1
(43) Pub. Date: Mar. 12, 2026

(54) BASE MEDIA SYSTEMS FOR VEHICLES

(71) Applicant: Harman Becker Automotive Systems GmbH, Karlsbad (DE)

(72) Inventor: Victor KALINICHENKO, Putzbrunn (DE)

(21) Appl. No.: 19/121,375

(22) PCT Filed: Nov. 24, 2022
(86) PCT No.: PCT/EP2022/083122

§ 371 Date: Apr. 15, 2025

(51) Int. Cl. H04N 21/462; H04N 21/414; H04N 21/436

(52) U.S. Cl. CPC H04N 21/4622; H04N 21/41422; H04N 21/43615

(57) ABSTRACT

Methods and systems are provided for enabling vehicular media systems incorporating a base media system (BMS) and an external media system (EMS). Methods may establish electronic communication links between a BMS installed in a vehicle and an EMS carried by the vehicle. A communication between the BMS and the EMS may identify one or more media channels for which the BMS is to receive streaming content from the EMS. The BMS may process a first media stream based on one or more media sources to create a first stream of content for the one or more media channels, and may receive from the EMS (over the point-to-point electronic communication link) a second stream of content for the one or more media channels. The BMS may select between providing the first stream of content or the second stream of content to an output interface coupled to one or more media sinks.

### FIELD

The disclosure relates to vehicle media systems, including systems capable of playing audio media, such as vehicle audio systems.

### BACKGROUND

Vehicle media systems (e.g., vehicle multi-media systems) may be capable of processing and playing various media signals, such as audio signals and/or video signals. In various embodiments, vehicle media systems may process and play media content (such as audio content) to create an impression for a listener of being in, and/or being surrounded by, any of a variety of atmospheres. For example, vehicle media systems may process audio content in such a way that, when played, it creates an impression of listening to the audio content while being on a seashore, or near a waterfall, or at a bustling open-air market, or in a stadium, or in a restaurant, or in the midst of a busy city, and so on. Vehicle media systems may accordingly process content in order to present an augmented-reality atmosphere to a listener, e.g., a user of the vehicle.

In some embodiments, audio signals may be processed to affect a direction associated with a sound, or to emulate an environment in which the sound may occur (e.g., by emulating a degree of spaciousness of such an environment). Some such embodiments may incorporate head-related impulse response (HRIR) modeling. Movement of sound sources over time may accordingly be emulated by such audio-signal processing. Similarly, in various embodiments, video effects may also be conditioned upon an environment in which the video content is being played. Moreover, for various embodiments, audio effects and/or video effects may be conditioned upon various environmental conditions (such as weather, time of day, season, geolocation, and/or the level of ambient noise) as well as other conditions (such as a category or genre of audio content and/or video content being played). In some embodiments, advanced audio processing may be undertaken to give the impression of a noise generated by the vehicle (e.g., an engine noise) being altered.

Such signal processing may make use of processors (e.g., Central Processing Units (CPUs)), controllers and/or microcontrollers, and memory and/or storage which may be more advanced and/or more robust than may be economically feasible to install in, for example, every car of a given model. While some vehicle purchasers may make use of the degree of hardware capabilities that may enable or facilitate augmented-reality media processing effects and/or other advanced media signal-processing effects (such as immersive augmented-reality audio effects), and may therefore be willing to pay for such hardware, other vehicle purchasers may not have an interest in such hardware capabilities and the costs associated with it. As a result, manufacturer-installed media systems for a given model of vehicle might not possess sufficient hardware to enable or facilitate augmented-reality media processing effects and/or other advanced media signal-processing effects (e.g., audio and/or video effects).

### SUMMARY

Disclosed herein are methods and systems for enabling or facilitating advanced vehicle media processing. In various embodiments, a vehicle may be equipped with a manufacturer-installed base media system (BMS). The BMS may have sufficient capability to accept various media inputs (e.g., audio inputs and/or video inputs), process the media inputs (e.g., including signal processing, such as digital signal processing (DSP)), and generate various media outputs (e.g., audio outputs and/or video outputs). For example, BMSes may have sufficient capability to accept a variety of audio inputs, process the audio inputs using various DSP algorithms, and generate any of a variety of audio outputs based on the processed audio inputs.

In addition, the BMS may also have an interface to an external media system (EMS). The interface may include a high-bandwidth upstreaming portion, a high-bandwidth downstreaming portion, and/or a control-signal portion. In some embodiments, the control-signal portion may be integrated within the high-bandwidth upstreaming portion and/or the high-bandwidth downstreaming portion.

In some embodiments, the EMS may be implemented as one or more cloud-computing devices located relatively remotely to the vehicle (e.g., as one or more servers and/or workstations). The BMS of the vehicle may be in wireless electronic communication over a relatively high-speed wireless electronic communication link with a network including cloud-computing devices implementing the EMS.

In other embodiments, the EMS may be implemented as a device that is separate from the BMS and/or separable from the BMS. In some embodiments, the EMS may be a portable device in the vehicle with the BMS, such as by being placed temporarily in the vehicle, or by being installed semi-permanently in the vehicle (e.g., in a fixture, cradle, or other feature of a cabin of the vehicle that may be suitable for and/or designed for the purpose of accepting the EMS). For some such embodiments, the BMS of the vehicle may be in wireless electronic communication over a relatively high-speed wireless electronic communication link, and/or in wired electronic communication over a relatively high-speed wired electronic communication link, with the separate EMS device. In addition, the EMS device may itself be in wireless electronic communication with an external system, e.g., one or more cloud-computing devices located relatively remotely to the vehicle, as discussed herein.

Whether the EMS is implemented as one or more remotely-located cloud-computing devices, or whether the EMS is implemented as a separate device placed in the vehicle and in wireless electronic communication with one or more remotely-located cloud-computing devices, the cloud-computing devices may include a collection of signal processing features, each of which may be employed by the EMS to implement an augmented-reality media processing effect or other advanced media signal-processing effect. When implemented as a separate device (e.g., to be placed in the vehicle), the EMS may download (or otherwise acquire or obtain) one or more signal processing features from the collection of signal processing features (for example, from a multimedia feature store on the Internet). Each feature may include, for example, one or more signal processing algorithms, parameters for use with such algorithms, and/or a set of data (e.g., audio data and/or video data) that may be used to implement an augmented-reality media processing effect and/or another advanced media signal-processing effect.

The EMS may include hardware sufficient to enable and/or facilitate augmented-reality media processing. Thus, while a given model of vehicle might be manufactured to include a BMS that does not possess hardware capabilities sufficient to enable and/or facilitate augmented-reality media processing effects and/or other advanced media signal-processing effects, an EMS may be used to interoperate with the BMS in order to provide the hardware capability to support such effects.

Accordingly, in various embodiments, a user of the BMS may request access to hardware capabilities for applying an advanced media signal-processing effect. The request may be forwarded (e.g., through the EMS) to the cloud-computing devices that include the collection of signal processing features. In some embodiments, such requests could include mechanisms for effecting payment before gaining access to the features (either permanently or for a limited time). For EMSes implemented as one or more cloud-computing devices, those features may be made available to the cloud-computing devices implementing the EMS, for use in applying the advanced media signal-processing effect in the cloud. For EMSes implemented as separate devices (e.g., for placement within a vehicle), those features may be downloaded by the EMS, for use locally (e.g., within the vehicle) in applying the advanced media signal-processing effect.

In some embodiments, a system for media signal processing for a vehicle may comprise audio and/or video source devices, audio and/or video sink devices, and a BMS with an output interface coupled to the audio and/or video sink devices. The system may also include one or more processors and a non-transitory memory storing executable instructions. The system may establish an electronic communication link between the BMS and an EMS, and may identify one or more media channels for which the BMS is to receive streaming content from the EMS (e.g., by a communication between the BMS and the EMS). In the BMS, a first media stream from the one or more media source devices may be processed to create a first stream of content for the one or more media channels. The BMS may receive a second stream of content for the one or more media channels from the EMS (e.g., over the point-to-point electronic communication link). The BMS may select between providing the first stream of content or the second stream of content to the output interface. In this way, a vehicle model may be manufactured to install or otherwise include the BMS, and the separate EMS may make advanced media-processing effects available to vehicles of that model.

In some embodiments, a method for media signal processing for a vehicle may comprise establishing an electronic communication link between a BMS within the vehicle and an EMS. A communication between the BMS and the EMS may establish one or more media channels for which the BMS is to receive streaming content from the EMS. In the BMS, a first media stream based on one or more media sources may be processed to create a first stream of content for the one or more media channels. The BMS may receive a second stream of content for the one or more media channels from the EMS (e.g., over the point-to-point electronic communication link). The BMS may then select between providing the first stream of content or the second stream of content to an output interface, which may be coupled to a variety of speakers (and/or other media sinks). In this way, hardware limitations of a BMS may be overcome by allowing the BMS to provide output from an EMS.

In some embodiments, a system for media signal processing for a vehicle may comprise various media (e.g., audio and/or video) source devices, various media (e.g., audio and/or video) sink devices, and a BMS installed in the vehicle, with the BMS having an output interface coupled to the media sink devices. The system may also comprise one or more processors and a non-transitory memory having various executable instructions. Some instructions may establish an electronic communication link between the BMS and an EMS carried by the vehicle. Some instructions may identify, via a communication between the BMS and the EMS, one or more media channels for which the BMS is to receive streaming content from the EMS. In the BMS, a first media stream from the one or more media source devices may be processed to create a first stream of content for the one or more identified media channels. In the EMS, a second media stream from the one or more media source devices may be processed to create a second stream of content for the one or more media channels. The BMS may receive the second stream of content for the one or more media channels from the EMS over the electronic communication link, and may select between providing the first stream of content or the second stream of content to the output interface. In this way, the BMS may make use of hardware capabilities and/or capacity in the EMS that the BMS may itself lack.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1 shows a schematic view of a design for a Base Media System (BMS) and an External Media System (EMS), in accordance with one or more embodiments of the present disclosure;

FIG. 2 shows a schematic view of a design for a BMS, in accordance with one or more embodiments of the present disclosure;

FIG. 3 shows a schematic view of a design for an EMS, in accordance with one or more embodiments of the present disclosure;

FIG. 4 shows a general architecture for a switching circuitry for one or more outputs of a BMS, in accordance with one or more embodiments of the present disclosure;

FIGS. 5-7 show usage models of a BMS and an EMS, in accordance with one or more embodiments of the present disclosure; and

FIGS. 6A and 6B show a method of interoperation between a BMS and an EMS, in accordance with one or more embodiments of the present disclosure.

### DETAILED DESCRIPTION

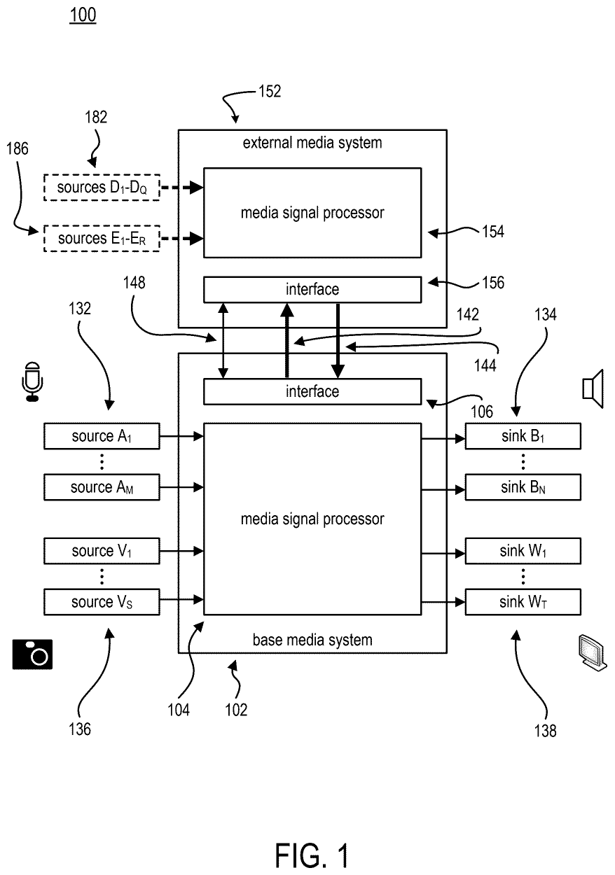

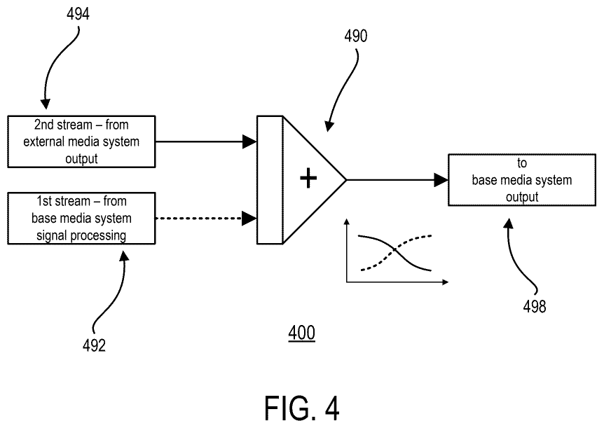

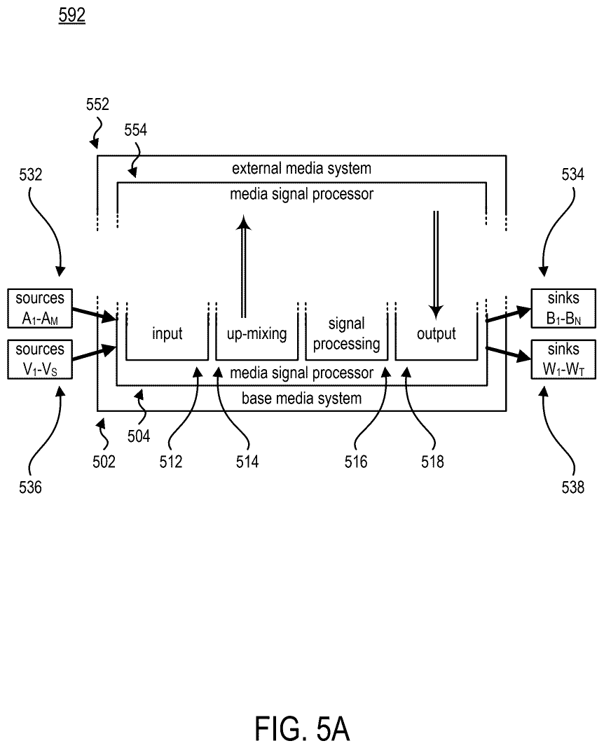

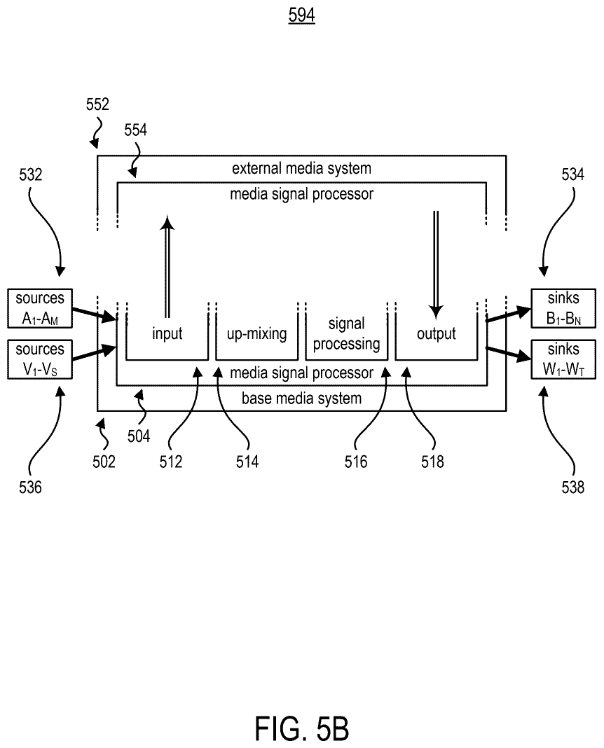

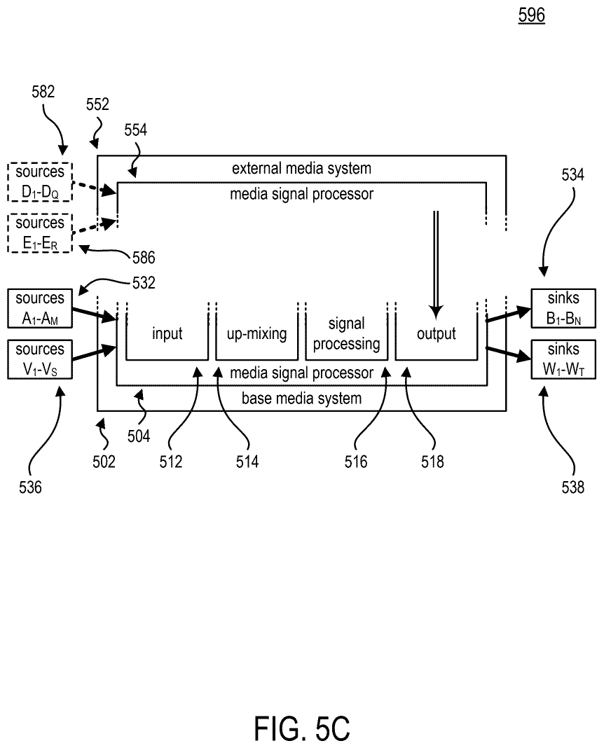

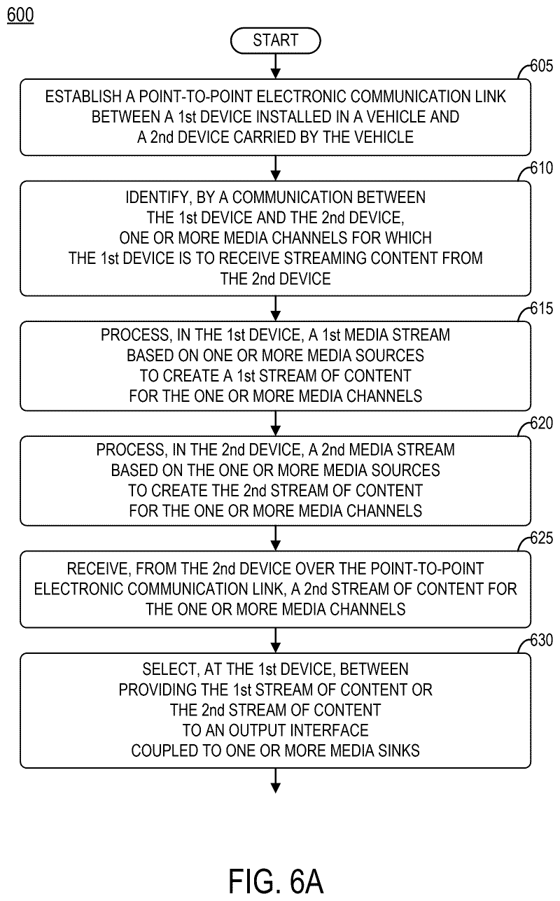

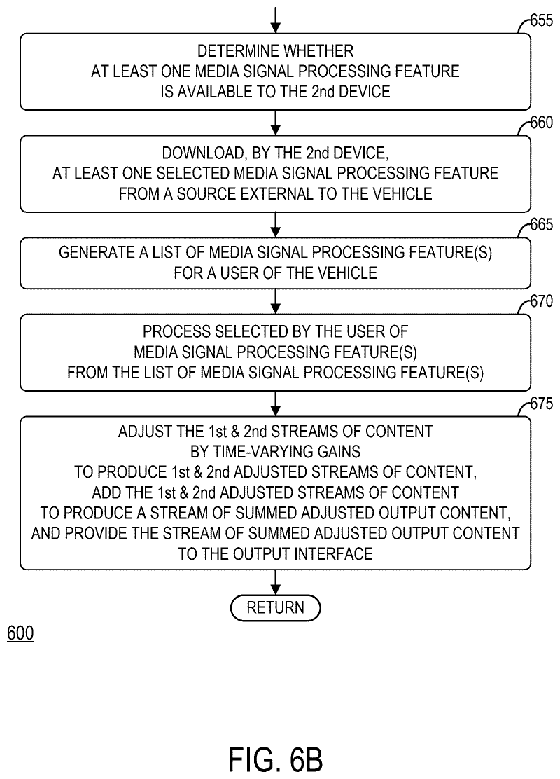

Disclosed herein are systems and methods for vehicular use of base media systems (BMSes) and interoperable external media system (EMSes). FIGS. 1-3 depict BMS designs and EMS designs, with FIG. 4 depicting an output portion of a BMS design. FIGS. 5A to 5C depict some possible usage models of BMSes and EMSes in accordance with the disclosure. FIGS. 6A and 6B

FIG. 1 shows a schematic view of a design 100 for a BMS 102 and an EMS 152. BMS 102 may include a BMS media signal processor 104 and a BMS interface portion 106. Similarly, EMS 152 may include an EMS media signal processor 154 and an EMS interface portion 156.

BMS media signal processor 104 may receive, and may subsequently process, inputs from various media sources. In some embodiments, BMS media signal processor 104 may receive audio inputs from one or more audio sources 132, such as a first audio source A₁, a second audio source A₂, and so on, through a last audio source A_{M}. In some embodiments, BMS media signal processor 104 may receive video inputs from one or more video sources 136, such as a first video source V₁, a second video source V₂, and so on, through a last video source V_{S}.

BMS media signal processor 104 may also generate, and may subsequently transmit, outputs to various media sinks. In some embodiments, BMS media signal processor 104 may transmit audio outputs to one or more audio sinks 134, such as a first audio sink B₁, a second audio sink B₂, and so on, through a last audio sink B_{M}. In some embodiments, BMS media signal processor 104 may transmit video outputs to one or more video sinks 138, such as a first video sink W₁, a second video sink W₂, and so on, through a last video sink W_{T}.

In some embodiments, the media sources may be devices separate from BMS 102, such as microphones, radio receivers, cameras, and/or any of a variety of media players (both audio and video). Similarly, in some embodiments, the media sinks may be devices separate from BMS 102, such as speakers and/or displays. For some embodiments, the media sources and/or media sinks may include portions of a VEHICLE INFOTAINMENT SYSTEM NNN, which may provide audio and/or video content (e.g., streaming audio and/or streaming video content) to BMS 102, and which may accept audio and/or video content (e.g. streaming audio and/or streaming video content) from BMS 102. For some embodiments, BMS 102 may be manufactured to include one or more media sources, such as one or more sources of audio content and/or video content (as discussed herein). Similarly, for some embodiments, BMS 102 may be manufactured to include one or more media sinks, such as one or more sinks of audio content and/or video content (as discussed herein). In some embodiments, media sources and/or media sinks as discussed herein may include portable computing and/or telecommunication devices, such as smart phones, smart watches, tablets, laptop computers, and so on.

Meanwhile, in some embodiments, EMS media signal processor 154 may also receive, and may subsequently process, inputs from various media sources. In some embodiments, EMS media signal processor 154 may receive audio inputs from one or more audio sources 182, such as a first audio source D₁ through a last audio source D_{Q}. In some embodiments, EMS media signal processor 154 may receive video inputs from one or more video sources 186, such as a first video source E₁ through a last video source E_{R}. In such embodiments, audio sources 182 may be substantially similar to, or the same as, audio sources 132, and video sources 186 may be substantially similar to, or the same as, video sources 136. As discussed further herein, in some embodiments of design 100, EMS 152 may receive some or all of the media signals that it processes from such as the same sources that BMS 102 receives, and accordingly might process the media signals it has received from those sources in addition to, or instead of, processing media signals received from BMS 102.

BMS media signal processor 104 and EMS media signal processor 154 may be in electronic communication with each other through BMS interface portion 106 and EMS interface portion 156. As a result, BMS 102 and EMS 152 may be in electronic communication with each other over one or more interfaces (with which BMS interface portion 106 and EMS interface portion 156 may be compliant), which may include an upstreaming portion 142, a downstreaming portion 144, and a control portion 148. In various embodiments, upstreaming portion 142, downstreaming portion 144, and/or control portion 148 may be implemented over a wired communication link or over a wireless electronic communication link. For example, in some embodiments, EMS 152 may be implemented as one as one or more cloud-computing devices located relatively remotely to the vehicle (e.g., as one or more remotely-located servers and/or workstations), and BMS 102 may be in wireless electronic communication with EMS 152. As an alternate example, in other embodiments, EMS 152 may be implemented as a device that is separate from BMS 102 and/or separable from BMS 102, and BMS 102 may be either in wired electronic communication or in wireless electronic communication with EMS 152.

In various embodiments, suitable wireless electronic communication links may include relatively high-speed wireless electronic communication links. In some embodiments, suitable communication links may be compliant with various revisions of cellular-network communication specifications promulgated by the Third Generation Partnership Project (3GPP), such as fifth-generation (5G) releases of the 3GPP specifications. For some embodiments, suitable communication links may be compliant various revisions of wireless network communication link specifications promulgated by the Wi-Fi Alliance, such as various parts of the Institute of Electrical and Electronics Engineers (IEEE) 802 set of specifications.

In some embodiments, BMS 102 in electronic communication with EMS 152 (either wired electronic communication or wireless electronic communication) through a vehicular network. In various embodiments, data passing over upstreaming portion 142 and/or downstreaming portion 144 of the one or more interfaces between BMS 102 and EMS 152 may be streaming substantially in real-time (perhaps with a relatively small delay).

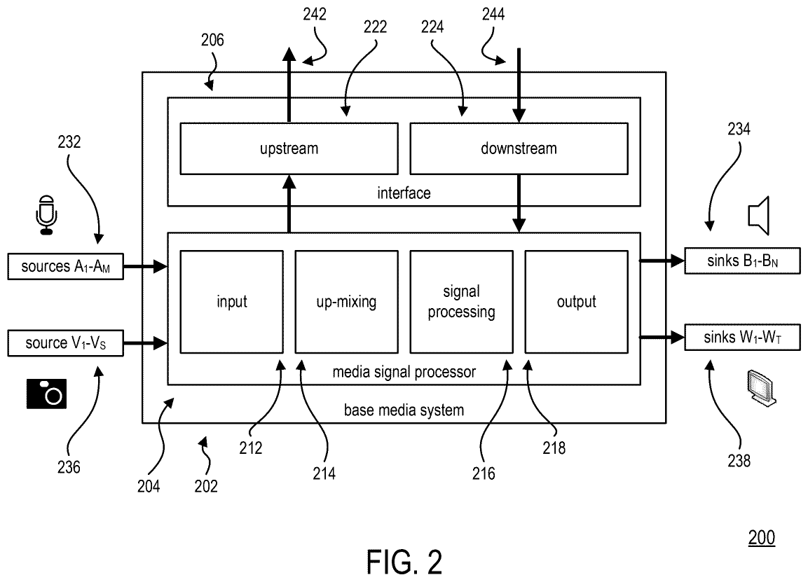

FIG. 2 shows a schematic view of a design 200 for a BMS 202 (which may be substantially similar to, or the same as, BMS 102). BMS 202 may include a media signal processor 204 and an interface portion 206 (which may themselves be substantially similar to, or the same as, BMS media signal processor 104 and BMS interface portion 106, respectively).

Media signal processor 204 may receive, and may subsequently process, inputs from one or more audio sources 232, such as a first audio source A₁ through a last audio source A_{M}, and/or from one or more video sources 236, such as a first video source V₁ through a last video source V_{S}. Media signal processor 204 may also generate, and may subsequently transmit, outputs to one or more audio sinks 234, such as a first audio sink B₁ through a last audio sink B_{M}, and/or one or more video sinks 238, such as a first video sink W₁ through a last video sink W_{T}.

Media signal processor 204 may be in electronic communication with an EMS (e.g., a media signaling portion of the EMS, as disclosed herein) through interface portion 206, and may as a result be in electronic communication with the EMS over one or more interfaces with which interface portion 206 may be compliant. The one or more interfaces may include an upstreaming portion 242, a downstreaming portion 244, and/or a control portion (unnumbered). The one or more interfaces may also be implemented by various portions of interface portion 206, such as an upstreaming portion 222 (which may implement upstreaming portion 242 of the one or more interfaces), a downstreaming portion 224 (which may implement downstreaming portion 244 of the one or more interfaces), and/or a control portion (unnumbered). The one or more interfaces may be implemented over a wired electronic communication link or over a wireless electronic communication link.

Media signal processor 204 may have an input portion 212, an up-mixing portion 214, a signal processing portion 216, and/or an output portion 218. Input portion 212 may receive various media signals, such as audio signals from audio sources 232 and/or video signals from video sources 236. The audio signals and/or the video signals may include streaming audio content and/or streaming video content (e.g., streams of media). In various embodiments, the audio signals and/or the video signals may be either analog signals or digital signals. In various embodiments, input portion 212 may buffer the audio signals and/or video signals it receives. Input portion 212 may provide audio (e.g., one or more audio streams) and/or video (e.g., one or more video streams) to up-mixing portion 214. In some embodiments, input portion 212 may provide video (e.g., one or more video streams) directly to signal processing portion 216 and/or output portion 218.

For various embodiments, input portion 212 may extract audio portions of video signals from video sources 236 for use as audio signals within media signal processor 204. In some embodiments, video (e.g., one or more video streams) provided directly to signal processing portion 216 and/or output portion 218 may include video portions extracted from video signals.

In up-mixing portion 214, the audio provided by input portion 212 may be mixed to form a set of audio channels. As examples, up-mixing portion 214 may form two channels (e.g., a left channel and a right channel), or six channels (e.g., a front-left channel, a front-right channel, a front-center channel, a back-left channel, a back-right channel, and a subwoofer channel). In various embodiments, up-mixing portion 214 may form any number of audio channels, each of which may correspond with at least one speaker in the vehicle. Up-mixing portion 214 may provide the set of audio channels to signal processing portion 216. In some embodiments, up-mixing portion 214 may provide audio channels based on audio portions extracted from video signals, up-mixed as discussed herein, to signal processing portion 216.

Signal processing portion 216 may comprise hardware resources for performing signal processing (e.g., digital signal processing) of audio signals (and/or video signals). For example, signal processing portion 216 may perform digital signal processing to apply surround effects to audio channels received from up-mixing portion 214 (e.g., multi-channel streaming audio content). In various embodiments, signal processing portion 216 may further up-mix audio channels received from up-mixing portion 214, e.g., into channels for specific speakers (whose number may depend on a predetermined number of speakers in an audio system of the vehicle). Processed audio channels (and/or other media channels, such as processed video content) may be provided to output portion 218.

Output portion 218 may receive media content, such as audio content (e.g., audio channels) and/or video content, from signal processing portion 216. In various embodiments, output portion 218 may receive video content from input portion 212 and/or up-mixing portion 214. In various embodiments, output portion 218 may buffer the audio content and/or video content it receives. The buffering may introduce a predetermined delay in the path to the BMS outputs, such as a delay (for example, of 10 milliseconds (ms)), which may facilitate quick transitions between media content processed by the BMS signal processing portion and media content processed by the EMS, in the event that real-time media streaming (e.g., downstreaming) experiences an interruption or irregularity. In some embodiments, output portion 218 may send audio content and/or video content it receives to one or more digital-to-analog converters (DACs). Output portion 218 may also provide protection to output devices (e.g. loudspeakers) from being damaged by signals of extremely high level, and/or may provide protection to DACs from having a digital signal level exceeding 1.0 (which may lead to “clipping” effects, which may sound unpleasant by human ear). Such protection may be provided by special algorithms (e.g., “limiters”).

For various embodiments, at least a portion of video content (e.g., at least video portions extracted from video signals) may be provided by input portion 212 to output portion 218, may pass through up-mixing portion 214 and/or signal processing portion 216, and/or may be processed by signal processing portion 216.

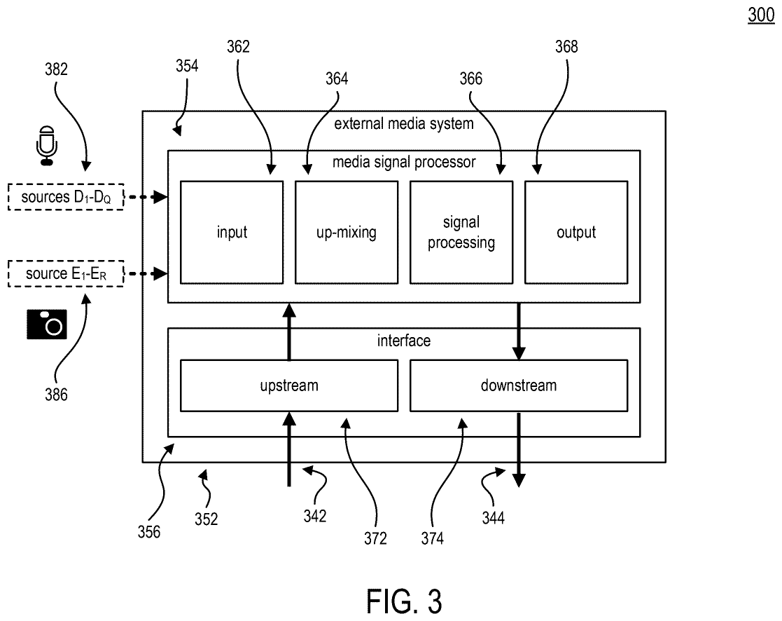

FIG. 3 shows a schematic view of a design 300 for an EMS 352 (which may be substantially similar to, or the same as, EMS 152). EMS 352 may include a media signal processor 354 and an interface portion 356 (which may themselves be substantially similar to, or the same as, EMS media signal processor 154 and EMS interface portion 156, respectively).

Media signal processor 354 may receive, and may subsequently process, inputs from one or more audio sources 382, such as a first audio source D₁ through a last audio source D_{Q}, and/or from one or more video sources 386, such as a first video source E₁ through a last video source E_{R}.

Media signal processor 354 may be in electronic communication with a BMS (e.g., a media signaling portion of the BMS, as disclosed herein) through interface portion 356, and may as a result be in electronic communication with the BMS over one or more interfaces with which interface portion 356 may be compliant. The one or more interfaces may include an upstreaming portion 342, a downstreaming portion 344, and/or a control portion (unnumbered). The one or more interfaces may also be implemented by various portions of interface portion 356, such as an upstreaming portion 372 (which may implement upstreaming portion 342 of the one or more interfaces), a downstreaming portion 374 (which may implement downstreaming portion 344 of the one or more interfaces), and/or a control portion (unnumbered). The one or more interfaces may be implemented over a wired electronic communication link or over a wireless electronic communication link.

Media signal processor 354 may have an input portion 362, an up-mixing portion 364, a signal processing portion 366, and/or an output portion 368. Input portion 362 may receive various media signals, such as audio signals from audio sources 382 and/or video signals from video sources 386. The audio signals and/or the video signals may include streaming audio content and/or streaming video content (e.g., streams of media). In various embodiments, the audio signals and/or the video signals may be either analog signals or digital signals. In various embodiments, input portion 362 may buffer the audio signals and/or video signals it receives. Input portion 362 may provide audio (e.g., one or more audio streams) and/or video (e.g., one or more video streams) to up-mixing portion 364. In some embodiments, input portion 362 may provide video (e.g., one or more video streams) directly to signal processing portion 366 and/or output portion 368.

For various embodiments, input portion 362 may extract audio portions of video signals from video sources 386 for use as audio signals within media signal processor 354. In some embodiments, video (e.g., one or more video streams) provided directly to signal processing portion 366 and/or output portion 368 may include video portions extracted from video signals.

In up-mixing portion 364, the audio provided by input portion 362 may be mixed to form a set of audio channels. As examples, up-mixing portion 364 may form two channels (e.g., a left channel and a right channel), or six channels (e.g., a front-left channel, a front-right channel, a front-center channel, a back-left channel, a back-right channel, and a subwoofer channel). In various embodiments, up-mixing portion 214 may form any number of audio channels, each of which may correspond with at least one speaker in the vehicle. Up-mixing portion 364 may provide the set of audio channels to signal processing portion 366. In some embodiments, up-mixing portion 364 may provide audio channels based on audio portions extracted from video signals, up-mixed as discussed herein, to signal processing portion 366.

Signal processing portion 366 may comprise hardware resources for performing signal processing (e.g., digital signal processing) of audio signals (and/or video signals). For example, signal processing portion 366 may perform digital signal processing to apply surround effects to audio channels received from up-mixing portion 364 (e.g., multi-channel streaming audio content). In various embodiments, signal processing portion 366 may further up-mix audio channels received from up-mixing portion 364, e.g., into channels for specific speakers (whose number may depend on a predetermined number of speakers in an audio system of the vehicle). Processed audio channels (and/or other media channels, such as processed video content) may be provided to output portion 368.

In comparison with signal processing portion 216 of BMS 202, signal processing portion 366 of EMS 302 may have significantly greater hardware capacity. That is, signal processing portion 366 may comprise processors, controllers and/or microcontrollers, and memory and/or storage which may be more capable and/or more robust than the processors, controllers and/or microcontrollers, and memory and/or storage of signal processing portion 216. Thus, a vehicle manufacturer may install BMS 202 across a significant portion of, or all of, manufactured vehicles of a given model; and vehicle purchasers may then obtain EMS 302 to interoperate with BMS 202 and thereby provide sufficient hardware capacity to enable or facilitate augmented-reality media processing effects and/or other advanced media signal-processing effects.

Output portion 368 may receive media content, such as audio content (e.g., audio channels) and/or video content, from signal processing portion 366. In various embodiments, output portion 368 may receive video content from input portion 362 and/or up-mixing portion 364. In various embodiments, output portion 368 may buffer the audio content and/or video content it receives. In some embodiments, output portion 368 may send audio content and/or video content it receives to one or more DACs.

For various embodiments, at least a portion of video content (e.g., at least video portions extracted from video signals) may be provided by input portion 362 to output portion 368, may pass through up-mixing portion 364 and/or signal processing portion 366, and/or may be processed by signal processing portion 366.

Specific usage models of BMSes (such as BMS 102 and BMS 202) and EMSes (such as EMS 152 and EMS 352) are discussed below, with reference to FIGS. 4-6.

FIG. 4 shows a design 400 for a switching circuitry for one or more outputs of a BMS. In design 400, a first stream of media content 492 from a signal processing portion of a BMS media signal processor may be provided to a first input of a switching circuitry 490, and a second stream of media content 494 from an output portion of an EMS media signal processor may be provided to a second input of switching circuitry 490. An output of switching circuitry 490 may then be provided to an output portion 498 of the BMS media signal processor. (In various embodiments, the BMS media signal processor may be substantially similar to, or the same as, BMS media signal processor 104 and/or media signal processor 204, and the EMS media signal processor may be substantially similar to, or the same as, EMS media signal processor 154 and/or media signal processor 354.)

As discussed herein, in various embodiments, a BMS may provide various media signals to an EMS (e.g., audio signals and/or video signals), the EMS may apply signal processing to the media signals, the EMS may provide the processed signals back to the BMS, and the BMS may then output the signals to various media sinks (e.g., speakers and/or displays). The signal processing applied by the EMS may enable and/or facilitate relatively more-advanced media effects due to the relatively more-advanced hardware capabilities of the EMS. During normal operation, switching circuitry 490 may provide second stream of media content 494 from the EMS to output portion 498 of the BMS.

Meanwhile, the BMS may continue to process the same media signals, potentially applying relatively less-advanced media effects due to the relatively less-advanced hardware capabilities of the BMS. During operation, the EMS may lose connectivity with the BMS, or a portion of the EMS and/or the BMS may run into a functional issue (e.g., very unpleasant audio side-effects, like plops, clicks or noises, which may frighten drivers and potentially impact vehicle safety), or some other issue, such that an interruption or irregularity is caused in the otherwise smooth downstreaming of second stream of media content 494 from the EMS. The reason for the functional issue may be that due to the interruption or irregularity, the content of associated audio buffers and/or video buffers may become temporarily invalid, which may be termed “digital garbage. ” Circuitry 400 may be applied in order to prevent this “digital garbage” from being sent to output devices. Notably, a downstreaming portion of a BMS (e.g., downstreaming portion 224 of BMS 202) may include buffering, which may add a delay to the streaming of second stream of media content 494. After the interruption or irregularity has been detected, the buffering may therefore be delayed from presenting the “digital garbage” in second stream of media content 494 to output devices for some time. During this delay time, switching circuitry 490 may smoothly transition to providing first stream of media content 492 to output portion 498 of the BMS, so that when the buffer is about to present the “digital garbage,” the switching process will have been finished. Thereafter, upon detecting an end to the interruption or other irregularity in the smoothness of the downstreaming, switching circuitry 490 may smoothly transition back to providing second stream of media content 494 from the EMS to output portion 498 of the BMS. In various embodiments, an interruption or irregularity may be established upon detection of data corrupted or expected data not being received (e.g., using time-stamps to detect lost packages, control sums to detect data corruption, and so on).

In other words, during normal operation, switching circuitry 490 may output a set of media signals as processed by the EMS and downstreamed to the BMS; upon detecting an interruption or irregularity in the set of media signals downstreamed to the BMS, switching circuitry 490 may output the set of media signals as processed by the BMS; and upon detecting an end of the interruption or irregularity in the set of media downstreamed to the BMS, switching circuitry 490 may return to outputting the set of media signals as processed by the EMS and downstreamed to the BMS.

A predetermined delay due to buffering (e.g., in output portion 218), such as a delay of at least 10 ms, may facilitate quick transitions between media content processed by the BMS signal processing portion and media content processed by the EMS, in the event that real-time media streaming (e.g., downstreaming) experiences an interruption or irregularity.

The principle of work of the circuitry 400 may be termed “cross-fading” or “cross-morphing. ” After having received a command to switch from passing the buffered second stream of media content 494 to output portion 498, to passing first stream of media content 492 to output portion 498, an input gain k₁ which may be applied to the digital signal of the buffered second stream of media content 494 may begin decreasing over time (e.g., from 1.0 to 0.0), while an input gain k₂ which may be applied to the digital signal in first stream of media content 492 may simultaneously begin increasing over time (e.g., from 0.0 to 1.0). The relation k₁+k₂=1.0 may be kept during the switching period in order to minimize and/or avoid volume change during the switching process.

Similarly, after having received a command to switch from passing first stream of media content 492 to output portion 498, to passing the buffered second stream of media content 494 to output portion 498—e.g., when the interruption or irregularity in second stream of media content 494 has ended—input gain k₁ applied to the digital signal of the buffered second stream of media content 494 may begin increasing over time (e.g., from 0.0 to 1.0), while input gain k₂ applied to the digital signal in first stream of media content 492 may simultaneously begin decreasing over time (e.g., from 1.0 to 0.0). As with the previous type of switching, the relation k₁+k₂=1.0 may be kept during the switching period in order to minimize and/or avoid volume change during the switching process.

FIGS. 5A-5C show examples of usage models of a BMS and an EMS. FIG. 5A shows a first usage model 592 that may encompass a BMS 502 and an EMS 552. (BMS 502 may be substantially similar to, or the same as, BMS 102 and/or BMS 202, and EMS 552 may be substantially similar to, or the same as, EMS 152 and/or EMS 352.) BMS 502 may include a BMS media signal processor 504 (which may be substantially similar to, or the same as, BMS media signal processor 104 and/or media signal processor 204). EMS 552 may include an EMS media signal processor 554 (which may be substantially similar to, or the same as, EMS media signal processor 154 and/or media signal processor 354).

Media signal processor 204 may have an input portion 512, an up-mixing portion 514, a signal processing portion 516, and/or an output portion 518. (Input portion 512, an up-mixing portion 514, a signal processing portion 516, and/or an output portion 518 may be substantially similar to, or the same as, input portion 212, an up-mixing portion 214, a signal processing portion 216, and/or an output portion 218, respectively.) BMS media signal processor 504 may receive as input, and may subsequently process, media content (e.g., streaming media content) from one or more audio sources 532 and/or from one or more video sources 536. BMS media signal processor 504 may also generate, and may subsequently transmit, outputs to one or more audio sinks 534 and/or one or more video sinks 538. (Audio sources 532, video sources 536, audio sinks 534, and video sinks 538 may be substantially similar to, or the same as, audio sources 232, video sources 236, audio sinks 234, and video sinks 238, respectively.)

In first usage model 592, BMS media signal processor 504 may up-mix media content, e.g., in up-mixing portion 514, and the up-mixed media content may then be provided to EMS media signal processor 554. The up-mixed media content may pass through an interface portion of BMS 502 and an interface portion of EMS 552 (of the sort discussed herein), and may be provided to an input portion of EMS media signal processor 554, an up-mixing portion of EMS media signal processor 554, and/or a signal processing portion of EMS media signal processor 554 (of the sort discussed herein). A signal processing portion of EMS media signal processor 554 may process the up-mixed media content (as discussed herein). Ultimately, an output portion of EMS media signal processor 554 may provide the processed media content to BMS media signal processor 504, e.g., to output portion 518 (as discussed herein).

In other words, in first usage model 592, BMS media signal processor 504 may perform some amount of up-mixing of media content, the up-mixed media content may be upstreamed to EMS media signal processor 554 and processed by EMS media signal processor 554, and the processed media content may be provided by EMS media signal processor 554 to BMS media signal processor 504.

FIG. 5B shows a second usage model 594 which is substantially similar to first usage model 592. However, in second usage model 594, BMS media signal processor 504 may provide media content to EMS media signal processor 554 before the media content is up-mixed, e.g., by input portion 512. EMS media signal processor 554 may then up-mix the media content, and/or process the media content (as discussed herein), and may provide the processed media content to BMS media signal processor 504. Ultimately, as in first usage model 592, the output portion of EMS media signal processor 554 may provide the processed media content to BMS media signal processor 504, e.g., to output portion 518 (as discussed herein).

In other words, in second usage model 594, BMS media signal processor 504 may merely upstream inputted media content (potentially buffered, as discussed herein) to EMS media signal processor 554, the media content may be up-mixed and processed by EMS media signal processor 554, and the processed media content may be provided by EMS media signal processor 554 to BMS media signal processor 504.

FIG. 5C shows a third usage model 596 which is substantially similar to first usage model 592 and second usage model 594. However, in third usage model 596, BMS media signal processor 504 might not provide media content to EMS media signal processor 554. Instead, an input portion of EMS media signal processor 554 may receive as input, and may subsequently process, media content (e.g., streaming media content) from one or more audio sources 582 and/or from one or more video sources 586 (which may be substantially similar to, or the same as, audio sources 532 and/or video sources 536). An up-mixing portion of EMS media signal processor 554 may up-mix the media content (as discussed herein), and a signal processing portion of EMS media signal processor 554 may process the up-mixed media content (as discussed herein). Ultimately, an output portion of EMS media signal processor 554 may provide the processed media content to BMS media signal processor 504, e.g., to output portion 518 (as discussed herein).

Accordingly, in various embodiments, media content to be processed and downstreamed from an EMS to a BMS may be up-mixed media content from the BMS (as in FIG. 5A), or inputted and possibly buffered media content from the BMS (as in FIG. 5B), or media content from audio sources and/or video sources (as in FIG. 5C). Following processing in the EMS (e.g., in a media signal processor of the EMS), the EMS may then downstream processed media content to the BMS, which may then select between outputting media content processed by the BMS, or media content processed by the EMS.

Accordingly, in a variety of embodiments, a system for media signal processing for a vehicle may comprise a set of media source devices (as discussed herein), a set of media sink devices (as discussed herein), and a first device installed in the vehicle (such as a BMS, as discussed herein). The first device may have an output interface (such as a BMS output portion, as discussed herein) coupled to the one or more media sink devices. A point-to-point electronic communication link may be established between the first device and a second device (such as an EMS, as discussed herein), e.g., through interface portions of the first device and the second device. The system may identify, by a communication between the first device and the second device, one or more media channels for which the first device is to receive streaming content from the second device (e.g., up-mixed media channels, as discussed herein). The first device may process a first media stream from the one or more media source devices (such as in a BMS signal processing portion, as discussed herein) to create a first stream of content for the one or more media channels, and may receive from the second device, over the point-to-point electronic communication link, a second stream of content for the one or more media channels. The first device may select (e.g., at a BMS output portion) between providing the first stream of content or the second stream of content to the output interface.

Similarly, for a variety of embodiments, a system for media signal processing for a vehicle may comprise a set of media source devices (as discussed herein), a set of media sink devices (as discussed herein), and first device installed in the vehicle (such as a BMS, as discussed herein). The first device may have an output interface (such as a BMS output portion, as discussed herein) coupled to the one or more media sink devices. A point-to-point electronic communication link between the first device and a second device carried by the vehicle (such as an EMS, as discussed herein), e.g., through interface portions of the first device and the second device. The system may identify, by a communication between the first device and the second device, one or more media channels for which the first device is to receive streaming content from the second device (e.g., up-mixed media channels, as discussed herein). The first device may process a first media stream from the one or more media source devices (such as in a BMS signal processing portion, as discussed herein) to create a first stream of content for the one or more media channels. The second device may process a second media stream from the one or more media source devices (such as in an EMS signal processing portion, as discussed herein) to create a second stream of content for the one or more media channels, and may provide the second stream of content for the one or more media channels to the first device over the point-to-point electronic communication link. The first device may select between providing the first stream of content or the second stream of content to the output interface (e.g., at a BMS output portion, as discussed herein).

FIGS. 6A and 6B shows an example of a method of interoperation between a BMS and an EMS, in accordance with one or more embodiments of the present disclosure. A method 600 may comprise an establishing 605, an identifying 610, a processing 615, a processing 620, a receiving 625, and/or a selecting 630. In various embodiments, method 600 may also comprise a determining 655, a downloading 660, a generating 665, a processing 670, and/or an adjusting 675.

In establishing 605, a point-to-point electronic communication link may be established between a first device installed in a vehicle (e.g., a BSM, as discussed herein) and a second device carried by the vehicle (e.g., an ESM, as discussed herein). For identifying 610, one or more media channels for which the first device is to receive streaming content from the second device may be identified, for example through a communication between the first device and the second device. In processing 615, a first media stream based on one or more media sources may be processed (e.g., by a BSM signal processing portion, as discussed herein) to create a first stream of content for the one or more media channels. In some embodiments, in processing 620, a second media stream based on one or more media sources may be processed (e.g., by an ESM, as discussed herein) to create a second stream of content for the one or more media channels. In receiving 625, a second stream of content for the one or more media channels from the second device may be received by the first device over the point-to-point electronic communication link. In selecting 630, at the first device, a selection may be made between providing the first stream of content or the second stream of content to an output interface (e.g., a BSM output portion, as discussed herein) coupled to one or more media sinks.

In some embodiments, the point-to-point electronic communication link may be a wired communication link. For some embodiments, the one or more media channels may be audio channels, the one or more media sources may be audio sources, and the one or more media sinks may be audio sinks.

In some embodiments, the processing in the first device of the first media stream is by a first digital signal processor (e.g., of a BMS signal processing portion, as discussed herein). For some embodiments, the processing in the second device of the second media stream is by a second digital signal processor (e.g., of an EMS signal processing portion, as discussed herein).

In some embodiments, in determining 655, a determination may be made by the first device as to whether at least one media signal processing feature is available to the second device. For some embodiments, in downloading 660, at least one selected media signal processing feature may be downloaded by the second device from a source external to the vehicle (e.g., following a purchase or subscription with an external system, such as a cloud-computing system, over a wireless electronic communications link between the EMS and the external system).

For some embodiments, the processing in the second device, is conditioned on an enabling of a corresponding media signal processing feature. In some embodiments, in generating 665, a list of one or more media signal processing features for a user of the vehicle may be generated by the first device. The list may include features available for the first device to use, in interoperation with the second device. For some embodiments, in processing 670, a selection by the user of at least one media signal processing feature from the list of one or more media signal processing features may be processed by the first device.

In some embodiments, in adjusting 675, while switching between providing the first stream of content to the output interface and providing the second stream of content to the output interface: the first stream of content may be adjusted by a first time-varying gain to produce a first adjusted stream of content; the second stream of content may be adjusted by a second time-varying gain to produce a second adjusted stream of content; the first adjusted stream of content and the second adjusted stream of content may be added to produce a stream of summed adjusted output content (e.g., by a BMS output portion); and the stream of summed adjusted output content may be provided to the output interface (e.g., of a BSM output portion).

For some embodiments, an intermediate media stream of the first device based on the first media stream (e.g., after being input to the BMS, or after being up-mixed by the BMS) may be provided by the first device to the second device over the point-to-point electronic communication link.

The methods may be configured for the operation of the systems disclosed herein. Thus, the same advantages that apply to the systems may apply to the methods.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices. The methods may be performed by executing stored instructions with one or more logic devices (e.g., processors) in combination with one or more additional hardware elements, such as storage devices, memory, image sensors/lens systems, light sensors, hardware network interfaces/antennas, switches, actuators, clock circuits, and so on. The described methods and associated actions may also be performed in various orders in addition to the order described in this application, in parallel, and/or simultaneously.

Note that the example control and estimation routines included herein can be used with various system configurations. The control methods and routines disclosed herein may be stored as executable instructions in non-transitory memory and may be carried out by the control system including the controller in combination with the various sensors, actuators, and other hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of a computer readable storage medium, where the described actions are carried out by executing the instructions in a system including the various hardware components in combination with the electronic controller.

The disclosure also provides support for a method comprising: establishing a point-to-point electronic communication link between a first device installed in a vehicle and a second device carried by the vehicle, identifying, by a communication between the first device and the second device, one or more media channels for which the first device is to receive streaming content from the second device, processing, in the first device, a first media stream based on one or more media sources to create a first stream of content for the one or more media channels, receiving, from the second device over the point-to-point electronic communication link to the first device, a second stream of content for the one or more media channels, and selecting, at the first device, between providing the first stream of content or the second stream of content to an output interface coupled to one or more media sinks. In a first example of the method, the point-to-point electronic communication link is a wired communication link. In a second example of the method, optionally including the first example, the one or more media channels are audio channels, wherein the one or more media sources are audio sources, and wherein the one or more media sinks are audio sinks. In a third example of the method, optionally including one or both of the first and second examples, the method further comprises: processing, in the second device, a second media stream based on the one or more media sources to create the second stream of content for the one or more media channels. In a fourth example of the method, optionally including one or more or each of the first through third examples, the processing, in the first device, of the first media stream is by a first digital signal processor, and wherein the processing, in the second device, of the second media stream is by a second digital signal processor. In a fifth example of the method, optionally including one or more or each of the first through fourth examples, the processing, in the second device, is conditioned on an enabling of a corresponding media signal processing feature. In a sixth example of the method, optionally including one or more or each of the first through fifth examples, the method further comprises: generating, by the first device, a list of one or more media signal processing features for a user of the vehicle, and processing, by the first device, at least one media signal processing feature selected by the user from the list of one or more media signal processing features. In a seventh example of the method, optionally including one or more or each of the first through sixth examples, the method further comprises: determining, by the first device, whether at least one media signal processing feature is available to the second device. In an eighth example of the method, optionally including one or more or each of the first through seventh examples, the method further comprises: downloading, by the second device, at least one selected media signal processing feature from a source external to the vehicle. In a ninth example of the method, optionally including one or more or each of the first through eighth examples, the method further comprises: while switching between providing the first stream of content to the output interface and providing the second stream of content to the output interface, adjusting the first stream of content by a first time-varying gain to produce a first adjusted stream of content, adjusting the second stream of content by a second time-varying gain to produce a second adjusted stream of content, adding the first adjusted stream of content and the second adjusted stream of content to produce a stream of summed adjusted output content, and providing the stream of summed adjusted output content to the output interface. In a tenth example of the method, optionally including one or more or each of the first through ninth examples, the method further comprises: providing, from the first device over the point-to-point electronic communication link to the second device, an intermediate media stream of the first device based on the first media stream.

The disclosure also provides support for a system for media signal processing for a vehicle, comprising: one or more media source devices, one or more media sink devices, a first device installed in the vehicle, the first device having an output interface coupled to the one or more media sink devices, one or more processors, and a non-transitory memory having executable instructions that, when executed, cause the one or more processors to: establish a point-to-point electronic communication link between the first device and a second device carried by the vehicle, identify, by a communication between the first device and the second device, one or more media channels for which the first device is to receive streaming content from the second device, process, in the first device, a first media stream from the one or more media source devices to create a first stream of content for the one or more media channels, process, in the second device, a second media stream from the one or more media source devices to create a second stream of content for the one or more media channels, provide, from the second device over the point-to-point electronic communication link to the first device, the second stream of content for the one or more media channels, and select, at the first device, between providing the first stream of content or the second stream of content to the output interface. In a first example of the system, the point-to-point electronic communication link is a wired communication link. In a second example of the system, optionally including the first example, the one or more media channels are audio channels, wherein the one or more media source devices are audio source devices, and wherein the one or more media sink devices are audio sink devices. In a third example of the system, optionally including one or both of the first and second examples, the processing, in the first device, of the first media stream is by a first digital signal processor, and wherein the processing, in the second device, of the second media stream is by a second digital signal processor. In a fourth example of the system, optionally including one or more or each of the first through third examples, the processing, in the second device, is conditioned on an enabling of a corresponding media signal processing feature. In a fifth example of the system, optionally including one or more or each of the first through fourth examples the executable instructions, when executed, causing the one or more processors to: generate, by the first device, a list of one or more media signal processing features for a user of the vehicle, and process, by the first device, at least one media signal processing feature selected by the user from the list of one or more media signal processing features. In a sixth example of the system, optionally including one or more or each of the first through fifth examples the executable instructions, when executed, causing the one or more processors to: determine, by the second device, at least one selected media signal processing feature from a source external to the vehicle. In a seventh example of the system, optionally including one or more or each of the first through sixth examples the executable instructions, when executed, causing the one or more processors to: download, by the second device, one or more media signal processing features from a source external to the vehicle. In an eighth example of the system, optionally including one or more or each of the first through seventh examples the executable instructions, when executed, causing the one or more processors to: while switching between providing the first stream of content to the output interface and providing the second stream of content to the output interface, adjust the first stream of content by a first time-varying gain to produce a first adjusted stream of content, adjust the second stream of content by a second time-varying gain to produce a second adjusted stream of content, add the first adjusted stream of content and the second adjusted stream of content to produce a stream of summed adjusted output content, and provide the stream of summed adjusted output content to the output interface. In a ninth example of the system, optionally including one or more or each of the first through eighth examples the executable instructions, when executed, causing the one or more processors to: provide, from the first device over the point-to-point electronic communication link to the second device, an intermediate media stream of the first device based on the first media stream.

The disclosure also provides support for a system for media signal processing for a vehicle, comprising: one or more media source devices, one or more media sink devices, a first device installed in the vehicle, the first device having an output interface coupled to the one or more media sink devices, one or more processors, and a non-transitory memory having executable instructions that, when executed, cause the one or more processors to: establish a point-to-point electronic communication link between the first device and a second device, identify, by a communication between the first device and the second device, one or more media channels for which the first device is to receive streaming content from the second device, process, in the first device, a first media stream from the one or more media source devices to create a first stream of content for the one or more media channels, receive, from the second device over the point-to-point electronic communication link to the first device, a second stream of content for the one or more media channels, and select, at the first device, between providing the first stream of content or the second stream of content to the output interface. In a first example of the system, the point-to-point electronic communication link is a wired communication link. In a second example of the system, optionally including the first example, the one or more media channels are audio channels, wherein the one or more media source devices are audio source devices, and wherein the one or more media sink devices are audio sink devices. In a third example of the system, optionally including one or both of the first and second examples the executable instructions, when executed, causing the one or more processors to: processing, in the second device, a second media stream based on the one or more media source devices to create the second stream of content for the one or more media channels. In a fourth example of the system, optionally including one or more or each of the first through third examples the executable instructions, when executed, causing the one or more processors to: wherein the processing, in the first device, of the first media stream is by a first digital signal processor, and wherein the processing, in the second device, of the second media stream is by a second digital signal processor. In a fifth example of the system, optionally including one or more or each of the first through fourth examples the executable instructions, when executed, causing the one or more processors to: wherein the processing, in the second device, is conditioned on an enabling of a corresponding media signal processing feature. In a sixth example of the system, optionally including one or more or each of the first through fifth examples the executable instructions, when executed, causing the one or more processors to: generate, by the first device, a list of one or more available media signal processing features for a user of the vehicle, and process, by the first device, at least one media signal processing feature selected by the user from the list of one or more media signal processing features. In a seventh example of the system, optionally including one or more or each of the first through sixth examples the executable instructions, when executed, causing the one or more processors to: determine, by the first device, whether the at least one media signal processing feature selected by the user is available to the second device. In an eighth example of the system, optionally including one or more or each of the first through seventh examples the executable instructions, when executed, causing the one or more processors to: download, by the second device, the at least one media signal processing feature selected by the user from a source external to the vehicle. In a ninth example of the system, optionally including one or more or each of the first through eighth examples the executable instructions, when executed, causing the one or more processors to: while switching between providing the first stream of content to the output interface and providing the second stream of content to the output interface, adjust the first stream of content by a first time-varying gain to produce a first adjusted stream of content, adjust the second stream of content by a second time-varying gain to produce a second adjusted stream of content, add the first adjusted stream of content and the second adjusted stream of content to produce a stream of summed adjusted output content, and provide the stream of summed adjusted output content to the output interface. In a tenth example of the system, optionally including one or more or each of the first through ninth examples the executable instructions, when executed, causing the one or more processors to: provide, from the first device over the point-to-point electronic communication link to the second device, an intermediate media stream of the first device based on the first media stream.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the vehicle systems and cloud computing systems described above with respect to FIGS. 1 through 6B. The methods may be performed by executing stored instructions with one or more logic devices (e.g., processors) in combination with one or more additional hardware elements, such as storage devices, memory, image sensors/lens systems, light sensors, hardware network interfaces/antennas, switches, actuators, clock circuits, and so on. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. Terms such as “first,” “second,” “third,” and so on are used merely as labels, and are not intended to impose numerical requirements or a particular positional order on their objects. The following claims particularly point out subject matter from the above disclosure that is regarded as novel and non-obvious.

1. A method comprising:
establishing a point-to-point electronic communication link between a first device installed in a vehicle and a second device carried by the vehicle;
identifying, by a communication between the first device and the second device, one or more media channels for which the first device is to receive streaming content from the second device;
processing, in the first device, a first media stream based on one or more media sources to create a first stream of content for the one or more media channels;
receiving, from the second device over the point-to-point electronic communication link to the first device, a second stream of content for the one or more media channels; and
selecting, at the first device, between providing the first stream of content or the second stream of content to an output interface coupled to one or more media sinks.

2. The method of claim 1,
wherein the point-to-point electronic communication link is a wired communication link.

3. The method of claim 1,
wherein the one or more media channels are audio channels;
wherein the one or more media sources are audio sources; and
wherein the one or more media sinks are audio sinks.

4. The method of claim 1, further comprising:
processing, in the second device, a second media stream based on the one or more media sources to create the second stream of content for the one or more media channels.

5. The method of claim 4,
wherein the processing, in the first device, of the first media stream is by a first digital signal processor; and
wherein the processing, in the second device, of the second media stream is by a second digital signal processor.

6. The method of claim 4,
wherein the processing, in the second device, is conditioned on an enabling of a corresponding media signal processing feature.

7. The method of claim 1, further comprising:
generating, by the first device, a list of one or more media signal processing features for a user of the vehicle; and
processing, by the first device, at least one media signal processing feature selected by the user from the list of one or more media signal processing features.

8. The method of claim 1, further comprising:
determining, by the first device, whether at least one media signal processing feature is available to the second device.

9. The method of claim 1, further comprising:
downloading, by the second device, at least one selected media signal processing feature from a source external to the vehicle.

10. The method of claim 1, further comprising:
while switching between providing the first stream of content to the output interface and providing the second stream of content to the output interface,
adjusting the first stream of content by a first time-varying gain to produce a first adjusted stream of content,
adjusting the second stream of content by a second time-varying gain to produce a second adjusted stream of content,
adding the first adjusted stream of content and the second adjusted stream of content to produce a stream of summed adjusted output content, and
providing the stream of summed adjusted output content to the output interface.

11. The method of claim 1, further comprising:
providing, from the first device over the point-to-point electronic communication link to the second device, an intermediate media stream of the first device based on the first media stream.

12. A system for media signal processing for a vehicle, comprising:
one or more media source devices;
one or more media sink devices;
a first device installed in the vehicle, the first device having an output interface coupled to the one or more media sink devices;
one or more processors; and
a non-transitory memory having executable instructions that, when executed, cause the one or more processors to:
establish a point-to-point electronic communication link between the first device and a second device carried by the vehicle;
identify, by a communication between the first device and the second device, one or more media channels for which the first device is to receive streaming content from the second device;
process, in the first device, a first media stream from the one or more media source devices to create a first stream of content for the one or more media channels;
process, in the second device, a second media stream from the one or more media source devices to create a second stream of content for the one or more media channels;
provide, from the second device over the point-to-point electronic communication link to the first device, the second stream of content for the one or more media channels; and
select, at the first device, between providing the first stream of content or the second stream of content to the output interface.

13. The system for media signal processing for a vehicle of claim 12,
wherein the point-to-point electronic communication link is a wired communication link.

14. The system for media signal processing for a vehicle of claim 12,
wherein the one or more media channels are audio channels;
wherein the one or more media source devices are audio source devices; and
wherein the one or more media sink devices are audio sink devices.

15. The system for media signal processing for a vehicle of claim 12,
wherein the processing, in the first device, of the first media stream is by a first digital signal processor; and
wherein the processing, in the second device, of the second media stream is by a second digital signal processor.

16. The system for media signal processing for a vehicle of claim 12,
wherein the processing, in the second device, is conditioned on an enabling of a corresponding media signal processing feature.

17. The system for media signal processing for a vehicle of claim 12, the executable instructions, when executed, causing the one or more processors to:
provide, from the first device over the point-to-point electronic communication link to the second device, an intermediate media stream of the first device based on the first media stream.

18. A system for media signal processing for a vehicle, comprising:
one or more media source devices;
one or more media sink devices;
a first device installed in the vehicle, the first device having an output interface coupled to the one or more media sink devices;
one or more processors; and
a non-transitory memory having executable instructions that, when executed, cause the one or more processors to:
establish a point-to-point electronic communication link between the first device and a second device;
identify, by a communication between the first device and the second device, one or more media channels for which the first device is to receive streaming content from the second device;
process, in the first device, a first media stream from the one or more media source devices to create a first stream of content for the one or more media channels;
receive, from the second device over the point-to-point electronic communication link to the first device, a second stream of content for the one or more media channels; and
select, at the first device, between providing the first stream of content or the second stream of content to the output interface.

19. The system for media signal processing for a vehicle of claim 18,
wherein the point-to-point electronic communication link is a wired communication link;
wherein the one or more media channels are audio channels;
wherein the one or more media source devices are audio source devices; and
wherein the one or more media sink devices are audio sink devices.

20. The system for media signal processing for a vehicle of claim 18, the executable instructions, when executed, causing the one or more processors to:
processing, in the second device, a second media stream based on the one or more media source devices to create the second stream of content for the one or more media channels.
